(19) United States
(12) Patent Application Publication
(10) Pub. No.: US 2023/0033800 A1
(43) Pub. Date: Feb. 2, 2023

(54) CLEANING DEVICE FOR A SMOKING SUBSTITUTE DEVICE

(71) Applicant: Nerudia Limited, Liverpool (GB)

(72) Inventors: Kate FERRIE, Liverpool (GB); Nikhill Aggarwal, Liverpool (GB); Peter Lomas, Liverpool (GB)

(21) Appl. No.: 17/813,472

(22) Filed: Jul. 19, 2022

Related U.S. Application Data
(63) Continuation of application No. PCT/EP21/51972, filed on Jan. 28, 2021.

(30) Foreign Application Priority Data
Jan. 28, 2020 (EP) 20153999.6
Jan. 28, 2020 (EP) 20154020.0

(51) Int. Cl. A24F 40/85; B08B 9/045; B08B 1/00; B08B 1/04; A46B 5/00

(52) U.S. Cl. CPC A24F 40/85; B08B 9/045; B08B 1/005; B08B 1/002; B08B 1/04; A46B 5/00; B08B 2209/04; A46B 2200/3073

(57) ABSTRACT

The present disclosure relates to a system for cleaning a smoking substitute device, and particularly, although not exclusively, to a system comprising a smoking substitute device and a cleaning device, further in particular to a cleaning device. In particular, the present disclosure relates to a cleaning device for cleaning a smoking substitute device, the cleaning device comprising a first section comprising a generally cylindrical outer surface, wherein at least part of the first section is adapted for insertion into a smoking substitute device consumable receiving cavity of a smoking substitute device, wherein at least part of the outer surface of the first section is adapted for cleaning the cavity, and wherein at least the first section is substantially rigid.

### CROSS-REFERENCE TO RELATED APPLICATIONS/INCORPORATION BY REFERENCE STATEMENT

This application is a non-provisional application claiming benefit to the international application no. PCT/EP2021/051972 filed on Jan. 28, 2021, which claims priority to EP 20153999.6 filed on Jan. 28, 2020 and to EP 20154020.0 filed on Jan. 28, 2020. The entire contents of each of the above-referenced applications are hereby incorporated herein by reference in their entirety.

### FIELD OF THE DISCLOSURE

The present disclosure relates to a system for cleaning a smoking substitute device, and particularly, although not exclusively, to a system comprising a smoking substitute device and a cleaning device, further in particular to a cleaning device.

### BACKGROUND

The smoking of tobacco is generally considered to expose a smoker to potentially harmful substances. It is generally thought that a significant amount of the potentially harmful substances are generated through the heat caused by the burning and/or combustion of the tobacco and the constituents of the burnt tobacco in the tobacco smoke itself.

Conventional combustible smoking articles, such as cigarettes, typically comprise a cylindrical rod of tobacco comprising shreds of tobacco which is surrounded by a wrapper, and usually also a cylindrical filter axially aligned in an abutting relationship with the wrapped tobacco rod. The filter typically comprises a filtration material which is circumscribed by a plug wrap. The wrapped tobacco rod and the filter are joined together by a wrapped band of tipping paper that circumscribes the entire length of the filter and an adjacent portion of the wrapped tobacco rod. A conventional cigarette of this type is used by lighting the end opposite to the filter, and burning the tobacco rod. The smoker receives mainstream smoke into their mouth by drawing on the mouth end or filter end of the cigarette.

Combustion of organic material such as tobacco is known to produce tar and other potentially harmful by-products. There have been proposed various smoking substitute systems (or “smoking substitute systems”) in order to avoid the smoking of tobacco.

Such smoking substitute systems can form part of nicotine replacement therapies aimed at people who wish to stop smoking and overcome a dependence on nicotine.

Smoking substitute systems include electronic systems that permit a user to simulate the act of smoking by producing an aerosol (also referred to as a “vapour”) that is drawn into the lungs through the mouth (inhaled) and then exhaled. The inhaled aerosol typically bears nicotine and/or flavourings without, or with fewer of, the odour and health risks associated with traditional smoking.

In general, smoking substitute systems are intended to provide a substitute for the rituals of smoking, whilst providing the user with a similar experience and satisfaction to those experienced with traditional smoking and with combustible tobacco products. Some smoking substitute systems use smoking substitute articles (also referred to as a “consumables”) that are designed to resemble a traditional cigarette and are cylindrical in form with a mouthpiece at one end.

The popularity and use of smoking substitute systems has grown rapidly in the past few years. Although originally marketed as an aid to assist habitual smokers wishing to quit tobacco smoking, consumers are increasingly viewing smoking substitute systems as desirable lifestyle accessories.

There are a number of different categories of smoking substitute systems, each utilising a different smoking substitute approach.

One approach for a smoking substitute system is the so-called Heated Tobacco (“HT”) approach in which tobacco (rather than an “e-liquid”) is heated or warmed to release vapour. HT is also known as “heat not burn” (“HNB”). The tobacco may be leaf tobacco or reconstituted tobacco. The vapour may contain nicotine and/or flavourings. In the HT approach the intention is that the tobacco is heated but not burned, i.e., the tobacco does not undergo combustion.

A typical HT smoking substitute system may include a device and a consumable. The consumable may include the tobacco material. The device and consumable may be configured to be physically coupled together. In use, heat may be imparted to the tobacco material by a heating element of the device, wherein airflow through the tobacco material causes components in the tobacco material to be released as vapour. A vapour may also be formed from a carrier in the tobacco material (this carrier may for example include propylene glycol and/or vegetable glycerine) and additionally volatile compounds released from the tobacco. The released vapour may be entrained in the airflow drawn through the tobacco.

As the vapour passes through the consumable (entrained in the airflow) from the location of vaporisation to an outlet of the consumable (e.g., a mouthpiece), the vapour cools and condenses to form an aerosol for inhalation by the user. The aerosol will normally contain the volatile compounds.

In HT smoking substitute systems, heating as opposed to burning the tobacco material is believed to cause fewer, or smaller quantities, of the more harmful compounds ordinarily produced during smoking. Consequently, the HT approach may reduce the odour and/or health risks that can arise through the burning, combustion and pyrolytic degradation of tobacco.

There may be a need for improved design of smoking substitute systems, in particular HT smoking substitute systems, to enhance the user experience and improve the function of the HT smoking substitute system.

The present disclosure has been devised in the light of the above considerations.

### SUMMARY OF THE DISCLOSURE

At its most general, the present disclosure relates to the cleaning of a smoking substitute device. In particular, the present disclosure relates to a system for cleaning a smoking substitute device, and particularly, although not exclusively, to a system comprising a smoking substitute device and a cleaning device, and further in particular to a cleaning device.

According to a first aspect of the present disclosure, there is provided a cleaning device for cleaning a smoking substitute device, the cleaning device comprising a first section comprising a generally cylindrical outer surface, wherein at least part of the first section is adapted for insertion into a smoking substitute device consumable receiving cavity of a smoking substitute device, wherein at least part of the outer surface of the first section is adapted for cleaning the cavity, and wherein at least the first section is substantially rigid.

In a second aspect, there is provided a system comprising a cleaning device according to the first aspect and a smoking substitute device.

In a third aspect, there is provided a method of cleaning a smoking substitute device by using a cleaning device according to the first aspect, comprising the steps of inserting the cleaning device into a cavity of the smoking substitute device, so that the first section is at least partially inserted into the cavity, and rotating the cleaning device to remove debris, dirt and/or deposits from at least one of the cavity, the inner wall surface of the cavity and the heating element of the smoking substitute device.

In a fourth aspect, there is provided a use of a cleaning device according to the first aspect of the present disclosure for cleaning a smoking substitute device.

By providing a cleaning device according to the present disclosure, an easy, quick and convenient cleaning of a smoking substitute device can be achieved. The cleaning device is insertable into a cavity of the smoking substitute device, preferably a consumable receiving cavity, or any other cavity that requires cleaning. The cleaning device is rigid so to withstand deformation when used for cleaning. In other words, the cleaning device may be used for scraping or grinding debris, deposits and dirt of elements of the smoking substitute device, like walls, cavities and the surface of the heater element. Likewise, an at least partially stuck consumable may be drilled out by the cleaning element. Here, the cleaning element may act as a drill or reamer type element for generally removing unwanted material from the smoking substitute device, like deposits or consumable material from walls, surfaces or the cavity in general.

The outer surface of the first section is adapted for cleaning the cavity by comprising at least one protrusion or fin having an end face, wherein the end face forms the generally cylindrical outer surface. The fin is arranged in a spiral. Here, spiral includes the fin completing a full turn around the cylindrical outer surface, more than one full turn and also less than one full turn. Importantly, the fin is arranged to be angled across an axial direction of the cylinder. That is, sides of the fin extend continuously at an angle to the axis of the generally cylindrical outer surface. Thus, the fin may operate when rotated using the Archimedes screw principal, wherein debris on the side, and in particular, an upwardly facing side, act to lift debris from the cavity.

A particular application may be that the cleaning device is designed to bore out any remaining tobacco material/debris or consumable material that becomes lodged within the smoking substitute device during use. A reamer or drill bit type helical sweep on the outer surface of the cleaning device may assist to dig out unwanted material and through rotation lifts or transports the material out of the device, e.g., the surface may comprise an It uses a basic Archimedes' screw principle. Initially, Archimedes' screw was a machine used for raising water from a low-lying body of water into to a higher location. Water is pumped by turning a screw-shaped surface inside a pipe. Archimedes' screws are also used for materials such as powders and grains, and in the case of the present disclosure, for debris, dirt, deposits and other material. By the open sided design of the outer surface of the cleaning device, the device may also be used to cut loose or scrape off material from other structures. Thereby, an easy way of removing unwanted debris from device is provided while reducing the chance of breakage on the current rod heater. The operation is intuitive in use and easy for the user of the smoking substitute device to do.

The term “rigid” is intended to refer to an element, in particular the first section or generally the cleaning device, to be stiff or inflexible, i.e., the physical properties of the element are such that it resists a bending or deformation when employed during regular use. This means that the element itself in not impacted but provided sufficient structural stiffness for removing, e.g., scraping off debris or deposits from the wall of a cavity. In particular, “rigid” shall express that the element is not flexible to an extent that its shape is formable or bendable, which would result in that a general shape can be changed for a particular use application, e.g., an element, like a solid wire or such, that is pliable so that it can be bent into a preferred shape by a user is not considered to constitute a rigid element.

Optional features will now be set out. These are applicable singly or in any combination with any aspect.

According to a further preferred embodiment, the generally cylindrical outer surface may comprise a surface structure for cleaning an inner wall surface of the cavity.

According to a further preferred embodiment, the surface structure may be one structure out of the group consisting of a rough surface structure, an abrasive surface structure, a structured surface structure, structured surface structure comprising a sharpened edge, a reamer type surface structure, and an Archimedes screw type surface structure.

According to a further preferred embodiment, the surface structure may be adapted for removing debris, dirt and/or deposits from the cavity and/or the inner wall surface of the cavity.

The outer surface of the cleaning device, in particular in the first section, may comprise a structure that is structured so to break up any debris, dirt or deposits found in the interior of the smoking substitute device. Likewise, if the surface is rough or abrasive, (softer) debris, dirt or deposits may be removed a certain part at a time, e.g., by scraping deposits off a wall, like the interior wall of a consumable receiving cavity. It may be beneficial if the surface of the cleaning device, the inner surface of the cavity and the surface of the heating element are made of a harder material than the expected debris or deposits, so to avoid wear of the cleaning device or damage to the smoking substitute device. Such material may be a metal or metal alloy, a carbon composite material or a sufficiently hard plastic material.

According to a further preferred embodiment, the surface structure may be arranged to transport deposits, dirt and/or debris from the cavity to the outside of the smoking substitute device.

According to a further preferred embodiment, the cleaning device may be adapted for rotation in the cavity for cleaning the cavity and/or for cleaning the inner wall surface of the cavity, in particular for transporting the deposits, dirt and/or debris from the cavity to the outside of the smoking substitute device.

The surface structure may be a spiral or an Archimedes' screw type surface structure, or simply a structure where available room for dislodged material between the inner wall of the cavity and the outer wall of the first section is larger towards a second section than at the first section. When rotating the cleaning element additional dislodged or scraped off debris, dirt or deposits are spiralled to the open end outside of the smoking substitute device, thereby removing the material from the cavity.

According to a further preferred embodiment, the cleaning device may further comprise a cavity for at least partly receiving a heating element of a smoking substitute device.

According to a further preferred embodiment, the cleaning device may be adapted for at least partly cleaning the heating element, in particular when the cleaning device is inserted, removed and/or rotated.

In other words, the cleaning device, e.g., in the first section, may comprise an opening adapted to the dimensions, location and shape of the heating element, so to accommodate the heating element. There may be a sufficient surface contact between the heating element and the cavity to clean the heating element. Further, or alternatively, the insertion of the cleaning device in the cavity of the smoking substitute device and thus the introduction of the heating element in the cavity in the first section may scrape off debris, dirt or deposits from the heating element and leave such material generally in the cavity of the smoking substitute device. This material then may be picked up by the outer surface structure of the cleaning device and be ultimately removed from the cavity of the smoking substitute device.

According to a further preferred embodiment, the cleaning device may further comprise a second section, wherein the second section is adapted for operation by a user of the smoking substitute device, in particular for inserting, removing and rotating the cleaning device when inserted in the smoking substitute device.

In other words, the cleaning device may have a handle or the like, which a user may user to initiate and maintain a rotation of the cleaning device, or to generally operate the device.

According to a further preferred embodiment, the smoking substitute device may comprise a cavity and a heating element.

According to a further preferred embodiment, the cleaning device may be adapted to clean the cavity and/or the heating element, in particular to remove debris, dirt and/or deposits from at least one of the cavity, the inner wall surface of the cavity and the heating element of the smoking substitute device.

According to a further preferred embodiment, removing debris, dirt and/or deposits from at least one of the cavity, the inner wall surface of the cavity and the heating element of the smoking substitute device may further comprise removing said debris, dirt and/or deposits from the smoking substitute device, in particular by rotating the cleaning device.

According to a fifth aspect of the present disclosure, there is provided a cleaning device for cleaning a smoking substitute device, the cleaning device comprising a first section adapted for insertion into a consumable receiving cavity of a smoking substitute device, a second section adapted for operation by a user, and a bearing element arranged between the first section and the second section.

According to a sixth aspect of the present disclosure, there is provided a system, comprising a cleaning device according to the fifth aspect of the present disclosure and a smoking substitute device.

According to a seventh aspect of the present disclosure, there is provided a method of cleaning a smoking substitute device by using a cleaning device according to the fifth aspect of the present disclosure, comprising the steps of inserting the cleaning device into a cavity of the smoking substitute device, and rotating the cleaning device about the heating element of the smoking substitute device and the bearing element.

According to an eighth aspect of the present disclosure, there is provided the use of a cleaning device according to the fifth aspect of the present disclosure for cleaning a smoking substitute device.

By providing a cleaning device according to the present disclosure may provide a simplified cleaning of a smoking substitute device, so that the cleaning may be performed regularly with ease and without undue burden. The cleaning device may easily and quickly be insertable into a consumable receiving cavity and may be turned or rotated by a user of the smoking substitute device, to clean the smoking substitute device. With the cleaning device according to the present disclosure, a cleaning may be performed substantially after each single user, and may also act as a closure or cap during use.

The term “bearing element” is intended to refer to a machine element that limits relative movement only to the desired movement and reduces friction between moving parts. For example, the design of the bearing may allow free linear movement of the moving part or free rotation about a fixed axis, or it may prevent movement by controlling the vectors of normal forces acting on the moving parts. Most bearings facilitate the desired movement by minimizing friction. Rotary bearings hold rotating components such as shafts or axles in mechanical systems and transmit axial and radial loads from the load source to the supporting structure. The simplest form of bearing, the plain bearing, consists of a shaft rotating in a bore. Lubrication is used to reduce friction. In the ball bearing and roller bearing, rolling elements such as rollers or balls with a circular cross-section are located between the raceways or journals of the bearing assembly to reduce sliding friction. In the context of the present disclosure, the bearing element in particular is intended to supports a rotatory movement of the first and second sections relative to the smoking substitute device.

Further optional features will now be set out. These are applicable singly or in any combination with any aspect.

According to a preferred embodiment of the present disclosure, when inserted into the cavity, the bearing element may be adapted to remain in a fixed position relative to the smoking substitute device when rotating the first section and the second section, and wherein the first section and the second section may be rotatable relative to the smoking substitute device and the bearing element.

According to a further preferred embodiment of the present disclosure, the second section may be adapted to remain outside of the smoking substitute device when the first section is inserted and while the cleaning device is being operated by the user, and wherein the first section and the second section may be rotatable relative to the smoking substitute device and in particular about the bearing element along a longitudinal axis of the smoking substitute device.

The bearing element may thus be arranged to get into a force fit or form fit with the body of the smoking substitute device, e.g., with the cavity, the inner walls of the cavity or at least a part thereof, or an opening of the body or the housing of the smoking substitute device in general, e.g., the bearing element may be arranged to be at least partly insertable into the opening of a smoking substitute device, and may engage with the opening in a force fit, press fit, or form fit, thereby removably attaching to the opening and thus fixing the smoking substitute device body and the bearing relative to one another in a defined manner. The bearing may subsequently allow the rotation of the first section and the second section relative to the bearing element and consequently relative to the body of the smoking substitute device. Thus, with the bearing being temporally or removably affixed to the body, the cleaning element, when inserted in the cavity, may turn in the cavity for cleaning the cavity or elements thereof, or generally the smoking substitute device.

According to a further preferred embodiment of the present disclosure, at least a first subsection of the first section may be adapted for cleaning the cavity and/or a heating element arranged in the cavity.

According to a further preferred embodiment of the present disclosure, the first section, at least with the first subsection, may comprise a surface structure for cleaning an inner wall surface of the cavity, in particular for removing debris, dirt and/or deposits from the cavity and/or the inner wall surface of the cavity.

According to a further preferred embodiment of the present disclosure, the surface structure may be one structure out of the group consisting of a rough surface structure, an abrasive surface structure, a structured surface structure, structured surface structure comprising a sharpened edge, and a brush type surface structure.

By a suitable first section or first subsection, a cleaning of the smoking substitute device, in particular the cavity or the parts thereof, like the inner surface, may be performed. The first section or first subsection, with in particular with its surface structure may clean the cavity or parts thereof. A structured surface may, e.g., remove debris, dirt or deposits from the surface or wall of the cavity, by brushing or scraping such material off the surface. Harder deposits may be removed by a rough or abrasive surface while softer deposits may be brushed off by a brush type surface structure. Due to the arrangement in the cavity using the bearing, the cleaning device may perform a rotating motion, so that the surface structure continuously and constantly moves over the surface to be cleaned, for removing the undesired material.

According to a further preferred embodiment of the present disclosure, the cleaning device may comprise a cavity for at least partly receiving a heating element of the smoking substitute device when inserted into the cavity.

According to a further preferred embodiment of the present disclosure, the cleaning device may be adapted to be rotated about the heating element.

According to a further preferred embodiment of the present disclosure, the cleaning device may be adapted for at least partly cleaning the heating element, in particular when the cleaning device is inserted, removed and/or rotated.

According to a further preferred embodiment of the present disclosure, the smoking substitute device may comprise a consumable receiving cavity, and a heating element arranged in the cavity, in particular a rotationally symmetric heating element, further in particular a rod shaped heating element, and wherein the cleaning device is adapted to be rotated about the heating element when inserted into the cavity.

Like the structured section of the cleaning element cleans a surface of the cavity, the cavity in the first section, in particular its inner surface engages with or comes in contact with the outer surface of the heating element. By bringing into contact, like sliding onto or removing from the heating element when inserting or removing the cleaning device from the cavity, the inner surface of the cavity of the first section and the outer surface of the heating element are already moved relative to one another to provide a cleaning function of the heating element. This cleaning function may further be enhanced by rotating the cleaning device in the cavity, thereby rotating the cavity in the first section about the heating element, thereby constantly and continuously cleaning the heating element. The rotation about the heating element may be supported by a rotationally symmetrical heating element, like a rod shaped heater. With a rotationally symmetrical heating element, the surface contact between the inner surface of the cavity of the first section and the outer surface of the heating element, may be established constantly and continuously while rotating the cleaning device about the heating element, thereby cleaning the heating element.

According to a further preferred embodiment of the present disclosure, the cleaning device may be adapted to remain in the smoking substitute device for an extended time acting as a cap for closing the cavity when the smoking substitute device is not in use.

In particular due to the previously described contact or removable fixation between the bearing element and the smoking substitute device, an unintentional removal of the cleaning device may he prevented, as it may in particular require some (non-neglectable) force to again remove the cleaning device. Thus, this may prevent the cleaning device from coming loose on its own or unintentionally, e.g., when transporting the smoking substitute device in a bag or pocket. The cleaning device located in the smoking substitute device may thus prevent debris or other unwanted material from entering the consumable receiving cavity or coming in contact with the heating element.

According to a further preferred embodiment of the present disclosure, the second section may comprise a structured surface for operating, in particular rotating, the cleaning device by a user holding the smoking substitute device while using a finger of the same hand that is holding the smoking substitute device for operation.

A structured surface may provide sufficient friction in order for a user holding the smoking substitute device to interact with the second section to initiate and maintain the rotation of the cleaning device in the cavity of the smoking substitute device, while overcoming the friction forces between the first section and the cavity wall as well as the cavity of the first section and the heating element. In particular, the second section may be a structured thumb wheel for fidgeting users to spin, thereby turning the first section and so cleaning the smoking substitute device.

The device may comprise an elongate body. An end of the elongate body may be configured for engagement with an aerosol-forming article. For example, the body may be configured for engagement with a heated tobacco (HT) consumable (or heat-not-burn (HNB) consumable). The terms “heated tobacco” and “heat-not-burn” are used interchangeably herein to describe a consumable that is of the type that is heated rather than combusted (or are used interchangeably to describe a device for use with such a consumable). The device may comprise a cavity that is configured for receipt of at least a portion of the consumable (i.e., for engagement with the consumable). The aerosol-forming article may be of the type that comprises an aerosol former (e.g., carried by an aerosol-forming substrate).

The device may comprise a heater for heating the aerosol-forming article. The heater may comprise a heating element, which may be in the form of a rod that extends from the body of the device. The heating element may extend from the end of the body that is configured for engagement with the aerosol-forming article.

The heater (and thus the heating element) may be rigidly mounted to the body. The heating element may be elongate so as to define a longitudinal axis and may, for example, have a transverse profile (i.e., transverse to a longitudinal axis of the heating element) that is substantially circular (i.e., the heating element may be generally cylindrical). Alternatively, the heating element may have a transverse profile that is rectangular (i.e., the heater may be a “blade heater”). The heating element may alternatively be in the shape of a tube (i.e., the heater may be a “tube heater”). The heating element may take other forms (e.g., the heating element may have an elliptical transverse profile). The shape and/or size (e.g., diameter) of the transverse profile of the heating element may be generally consistent for the entire length (or substantially the entire length) of the heating element.

The heating element may be between 15 mm and 25 mm long, e.g., between 18 mm and 20 mm long, e.g., around 19 mm long. The heating element may have a diameter of between 1.5 mm and 2.5 mm, e.g., a diameter between 2 mm and 2.3 mm, e.g., a diameter of around 2.15 mm.

The heating element may be formed of ceramic. The heating element may comprise a core (e.g., a ceramic core) comprising Al2O3. The core of the heating element may have a diameter of 1.8 mm to 2.1 mm, e.g., between 1.9 mm and 2 mm. The heating element may comprise an outer layer (e.g., an outer ceramic layer) comprising Al2O3. The thickness of the outer layer may be between 160 μm and 220 μm, e.g., between 170 μm and 190 μm, e.g., around 180 μm. The heating element may comprise a heating track, which may extend longitudinally along the heating element. The heating track may be sandwiched between the outer layer and the core of the heating element. The heating track may comprise tungsten and/or rhenium. The heating track may have a thickness of around 20 μm.

The heating element may be located in the cavity (of the device), and may extend (e.g., along a longitudinal axis) from an internal base of the cavity towards an opening of the cavity. The length of the heating element (i.e., along the longitudinal axis of the heater) may be less than the depth of the cavity. Hence, the heating element may extend for only a portion of the length of the cavity. That is, the heating element may not extend through (or beyond) the opening of the cavity.

The heating element may be configured for insertion into an aerosol-forming article (e.g., a HT consumable) when an aerosol-forming article is received in the cavity. In that respect, a distal end (i.e., distal from a base of the heating element where it is mounted to the device) of the heating element may comprise a tapered portion, which may facilitate insertion of the heating element into the aerosol-forming article. The heating element may fully penetrate an aerosol-forming article when the aerosol-forming article is received in the cavity. That is, the entire length, or substantially the entire length, of the heating element may be received in the aerosol-forming article.

The heating element may have a length that is less than, or substantially the same as, an axial length of an aerosol-forming substrate forming part of an aerosol-forming article (e.g., a HT consumable). Thus, when such an aerosol-forming article is engaged with the device, the heating element may only penetrate the aerosol-forming substrate, rather than other components of the aerosol-forming article. The heating element may penetrate the aerosol-forming substrate for substantially the entire axial length of the aerosol forming-substrate of the aerosol-forming article. Thus, heat may be transferred from (e.g., an outer circumferential surface of) the heating element to the surrounding aerosol-forming substrate, when penetrated by the heating element. That is, heat may be transferred radially outwardly (in the case of a cylindrical heating element) or, e.g., radially inwardly (in the case of a tube heater).

Where the heater is a tube heater, the heating element of the tube heater may surround at least a portion of the cavity. When the portion of the aerosol-forming article is received in the cavity, the heating element may surround a portion of the aerosol-forming article (i.e., so as to heat that portion of the aerosol-forming article). In particular, the heating element may surround an aerosol forming substrate of the aerosol-forming article. That is, when an aerosol-forming article is engaged with the device, the aerosol forming substrate of the aerosol-forming article may be located adjacent an inner surface of the (tubular) heating element. When the heating element is activated, heat may be transferred radially inwardly from the inner surface of the heating element to heat the aerosol forming substrate.

The cavity may comprise a (e.g., circumferential) wall (or walls) and the (tubular) heating element may extend around at least a portion of the wall(s). In this way, the wall may be located between the inner surface of the heating element and an outer surface of the aerosol-forming article. The wall (or walls) of the cavity may be formed from a thermally conductive material (e.g., a metal) to allow heat conduction from the heating element to the aerosol-forming article. Thus, heat may be conducted from the heating element, through the cavity wall (or walls), to the aerosol-forming substrate of an aerosol-forming article received in the cavity.

In some embodiments the device may comprise a cap disposed at the end of the body that is configured for engagement with an aerosol-forming article. Where the device comprises a heater having a heating element, the cap may at least partially enclose the heating element. The cap may be moveable between an open position in which access is provided to the heating element, and a closed position in which the cap at least partially encloses the heating element. The cap may be slideably engaged with the body of the device, and may be slideable between the open and closed positions.

The cap may define at least a portion of the cavity of the device. That is, the cavity may be fully defined by the cap, or each of the cap and body may define a portion of the cavity. Where the cap fully defines the cavity, the cap may comprise an aperture for receipt of the heating element into the cavity (when the cap is in the closed position). The cap may comprise an opening to the cavity. The opening may be configured for receipt of at least a portion of an aerosol-forming article. That is, an aerosol-forming article may be inserted through the opening and into the cavity (so as to be engaged with the device).

The cap may be configured such that when an aerosol-forming article is engaged with the device (e.g., received in the cavity), only a portion of the aerosol-forming article is received in the cavity. That is, a portion of the aerosol-forming article (not received in the cavity) may protrude from (i.e., extend beyond) the opening. This (protruding) portion of the aerosol-forming article may be a terminal (e.g., mouth) end of the aerosol-forming article, which may be received in a user's mouth for the purpose of inhaling aerosol formed by the device.

The device may comprise a power source or may be connectable to a power source (e.g., a power source separate to the device). The power source may be electrically connectable to the heater. In that respect, altering (e.g., toggling) the electrical connection of the power source to the heater may affect a state of the heater. For example, toggling the electrical connection of the power source to the heater may toggle the heater between an on state and an off state. The power source may be a power store. For example, the power source may be a battery or rechargeable battery (e.g., a lithium-ion battery).

The device may comprise an input connection (e.g., a USB port, Micro USB port, USB-C port, etc.). The input connection may be configured for connection to an external source of electrical power, such as a mains electrical supply outlet. The input connection may, in some cases, be used as a substitute for an internal power source (e.g., battery or rechargeable battery). That is, the input connection may be electrically connectable to the heater (for providing power to the heater). Hence, in some forms, the input connection may form at least part of the power source of the device.

Where the power source comprises a rechargeable power source (such as a rechargeable battery), the input connection may be used to charge and recharge the power source.

The device may comprise a user interface (UI). In some embodiments the UI may include input means to receive operative commands from the user. The input means of the UI may allow the user to control at least one aspect of the operation of the device. In some embodiments the input means may comprise a power button to switch the device between an on state and an off state.

In some embodiments the UI may additionally or alternatively comprise output means to convey information to the user. In some embodiments the output means may comprise a light to indicate a condition of the device (and/or the aerosol-forming article) to the user. The condition of the device (and/or aerosol-forming article) indicated to the user may comprise a condition indicative of the operation of the heater. For example, the condition may comprise whether the heater is in an off state or an on state. In some embodiments, the UI unit may comprise at least one of a button, a display, a touchscreen, a switch, a light, and the like. For example, the output means may comprise one or more (e.g., two, three, four, etc.) light-emitting diodes (“LEDs”) that may be located on the body of the device.

The device may further comprise a puff sensor (e.g., airflow sensor), which form part of the input means of the UI. The puff sensor may be configured to detect a user drawing on an end (i.e., a terminal (mouth) end) of the aerosol-forming article. The puff sensor may, for example, be a pressure sensor or a microphone. The puff sensor may be configured to produce a signal indicative of a puff state. The signal may be indicative of the user drawing (an aerosol from the aerosol-forming article) such that it is, e.g., in the form of a binary signal. Alternatively, or additionally, the signal may be indicative of a characteristic of the draw (e.g., a flow rate of the draw, length of time of the draw, etc.).

The device may comprise a controller, or may be connectable to a controller that may be configured to control at least one function of the device. The controller may comprise a microcontroller that may, e.g., be mounted on a printed circuit board (PCB). The controller may also comprise a memory, e.g., non-volatile memory. The memory may include instructions, which, when implemented, may cause the controller to perform certain tasks or steps of a method. Where the device comprises an input connection, the controller may be connected to the input connection.

The controller may be configured to control the operation of the heater (and, e.g., the heating element). Thus, the controller may be configured to control vaporisation of an aerosol forming part of an aerosol-forming article engaged with the device. The controller may be configured to control the voltage applied by power source to the heater. For example, the controller may be configured to toggle between applying a full output voltage (of the power source) to the heater and applying no voltage to the heater. Alternatively, or additionally, the control unit may implement a more complex heater control protocol.

The device may further comprise a voltage regulator to regulate the output voltage supplied by the power source to form a regulated voltage. The regulated voltage may subsequently be applied to the heater.

In some embodiments, where the device comprises a UI, the controller may be operatively connected to one or more components of the UI. The controller may be configured to receive command signals from an input means of the UI. The controller may be configured to control the heater in response to the command signals. For example, the controller may be configured to receive “on” and “off” command signals from the UI and, in response, may control the heater so as to be in a corresponding on or off state.

The controller may be configured to send output signals to a component of the UI. The UI may be configured to convey information to a user, via an output means, in response to such output signals (received from the controller). For example, where the device comprises one or more LEDs, the LEDs may be operatively connected to the controller. Hence, the controller may configured to control the illumination of the LEDs (e.g., in response to an output signal). For example, the controller may be configured to control the illumination of the LEDs according to (e.g., an on or off) state of the heater.

Where the device comprises a sensor (e.g., a puff/airflow sensor), the controller may be operatively connected to the sensor. The controller may be configured to receive a signal from the sensor (e.g., indicative of a condition of the device and/or engaged aerosol-forming article). The controller may be configured to control the heater, or an aspect of the output means, based on the signal from the sensor.

The device may comprise a wireless interface configured to communicate wirelessly (e.g., via Bluetooth (e.g., a Bluetooth low-energy connection) or WIFI) with an external device. Similarly, the input connection may be configured for wired connection to an external device so as to provide communication between the device and the external device.

The external device may be a mobile device. For example, the external device may be a smart phone, tablet, smart watch, or smart car. An application (e.g., app) may be installed on the external device (e.g., mobile device). The application may facilitate communication between the device and the external device via the wired or wireless connection.

The wireless or wired interface may be configured to transfer signals between the external device and the controller of the device. In this respect, the controller may control an aspect of the device in response to a signal received from an external device. Alternatively, or additionally, an external device may respond to a signal received from the device (e.g., from the controller of the device).

An aerosol-forming article may comprise an aerosol-forming substrate at an upstream end of the aerosol-forming article. The article may be in the form of a smoking substitute article, e.g., heated tobacco (HT) consumable (also known as a heat-not-burn (HNB) consumable).

As used herein, the terms “upstream” and “downstream” are intended to refer to the flow direction of the vapour/aerosol, i.e., with the downstream end of the article/consumable being the mouth end or outlet where the aerosol exits the consumable for inhalation by the user. The upstream end of the article/consumable is the opposing end to the downstream end.

The aerosol-forming substrate is capable of being heated to release at least one volatile compound that can form an aerosol. The aerosol-forming substrate may be located at the upstream end of the article/consumable.

In order to generate an aerosol, the aerosol-forming substrate comprises at least one volatile compound that is intended to be vaporised/aerosolised and that may provide the user with a recreational and/or medicinal effect when inhaled. Suitable chemical and/or physiologically active volatile compounds include the group consisting of: nicotine, cocaine, caffeine, opiates and opioids, cathine and cathinone, kavalactones, mysticin, beta-carboline alkaloids, salvinorin A together with any combinations, functional equivalents to, and/or synthetic alternatives of the foregoing.

The aerosol-forming substrate may comprise plant material. The plant material may comprise least one plant material selected from the list including Amaranthus dubius, Arctostaphylos uva-ursi (Bearberry), Argemone mexicana, Amica, Artemisia vulgaris, Yellow Tees, Galea zacatechichi, Canavalia maritima (Baybean), Cecropia mexicana (Guamura), Cestrum noctumum, Cynoglossum virginianum (wild comfrey), Cytisus scoparius, Damiana, Entada rheedii, Eschscholzia californica (California Poppy), Fittonia albivenis, Hippobroma longiflora, Humulus japonica (Japanese Hops), Humulus lupulus (Hops), Lactuca virosa (Lettuce Opium), Laggera alata, Leonotis leonurus, Leonurus cardiaca (Motherwort), Leonurus sibiricus (Honeyweed), Lobelia cardinalis, Lobelia inflata (Indian-tobacco). Lobelia siphilitica, Nepeta cataria (Catnip), Nicotiana species (Tobacco), Nymphaea alba (White Lily), Nymphaea caerulea (Blue Lily), Opium poppy, Passiflora incamata (Passionflower), Pedicularis densiflora (Indian Warrior), Pedicularis groenlandica (Elephant's Head), Salvia divinorum, Salvia dorrii (Tobacco Sage), Salvia species (Sage), Scutellaria galericulata, Scutellaria lateriflora, Scutellaria nana, Scutellaria species (Skullcap), Sida acuta (Wireweed), Sida rhombifolia, Silene capensis, Syzygium aromaticum (Clove), Tagetes lucida (Mexican Tarragon), Tarchonanthus camphoratus, Tumera diffusa (Damiana), Verbascum (Mullein), Zamia latifolia (Maconha Brava) together with any combinations, functional equivalents to, and/or synthetic alternatives of the foregoing.

The plant material may be tobacco. Any type of tobacco may be used. This includes, but is not limited to, flue-cured tobacco, burley tobacco, Maryland Tobacco, dark-air cured tobacco, oriental tobacco, dark-fired tobacco, perique tobacco and rustica tobacco. This also includes blends of the above mentioned tobaccos.

The tobacco may comprise one or more of leaf tobacco, stem tobacco, tobacco powder, tobacco dust, tobacco derivatives, expanded tobacco, homogenised tobacco, shredded tobacco, extruded tobacco, cut rag tobacco and/or reconstituted tobacco (e.g., slurry recon or paper recon).

The aerosol-forming substrate may comprise a gathered sheet of homogenised (e.g., paper/slurry recon) tobacco or gathered shreds/strips formed from such a sheet.

The aerosol-forming substrate may comprise one or more additives selected from humectants, flavourants, fillers, aqueous/non-aqueous solvents and binders.

The flavourant may be provided in solid or liquid form. It may include menthol, liquorice, chocolate, fruit flavour (including, e.g., citrus, cherry etc.), vanilla, spice (e.g., ginger, cinnamon) and tobacco flavour. The flavourant may be evenly dispersed throughout the aerosol-forming substrate or may be provided in isolated locations and/or varying concentrations throughout the aerosol-forming substrate.

The aerosol-forming substrate may be formed in a substantially cylindrical shape such that the article/consumable resembles a conventional cigarette. It may have a diameter of between 5 and 10 mm, e.g., between 6 and 9 mm or 6 and 8 mm, e.g., around 7 mm. It may have an axial length of between 10 and 15 mm, e.g., between 11 and 14 mm such as around 12 or 13 mm.

The article consumable may comprise at least one filter element. There may be a terminal filter element at the downstream/mouth end of the article/consumable.

The at least one of the filter element(s) (e.g., the terminal filter element) may be comprised of cellulose acetate or polypropylene tow. The at least one filter element (e.g., the terminal filter element) may be comprised of activated charcoal. The at least one filter element (e.g., the terminal element) may be comprised of paper. The or each filter element may be at least partly (e.g., entirely) circumscribed with a plug wrap, e.g., a paper plug wrap.

The terminal filter element (at the downstream end of the article/consumable) may be joined to the upstream elements forming the article/consumable by a circumscribing tipping layer, e.g., a tipping paper layer. The tipping paper may have an axial length longer than the axial length of the terminal filter element such that the tipping paper completely circumscribes the terminal filter element plus the wrapping layer surrounding any adjacent upstream element.

In some embodiments, the article/consumable may comprise an aerosol-cooling element which is adapted to cool the aerosol generated from the aerosol-forming substrate (by heat exchange) before being inhaled by the user.

The article/consumable may comprise a spacer element that defines a space or cavity between the aerosol-forming substrate and the downstream end of the consumable. The spacer element may comprise a cardboard tube. The spacer element may be circumscribed by the (paper) wrapping layer.

The disclosure includes the combination of the aspects and preferred features described except where such a combination is clearly impermissible or expressly avoided.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

So that the disclosure may be understood, and so that further aspects and features thereof may be appreciated, embodiments illustrating the principles of the disclosure will now be discussed in further detail with reference to the accompanying figures, in which:

FIG. 1A is a schematic of a smoking substitute system;

FIG. 1B is a schematic of a variation of the smoking substitute system of FIG. 1A;

FIG. 2A is a front view of a first embodiment of a smoking substitute system with the consumable engaged with the device;

FIG. 2B is a front view of the first embodiment of the smoking substitute system with the consumable disengaged from the device;

FIG. 2C is a section view of the consumable of the first embodiment of the smoking substitute system;

FIG. 2D is a detailed view of an end of the device of the first embodiment of the smoking substitute system;

FIG. 2E is a section view of the first embodiment of the smoking substitute system;

FIG. 3A is a view of an exemplary embodiment of the cleaning device according to the present disclosure;

FIG. 3B is an exemplary mode of operation of the cleaning device of FIG. 3A according to the present disclosure;

FIG. 4A is a detailed view of another exemplary cleaning device according to the present disclosure; and

FIG. 4B is a detailed view of the cleaning device of FIG. 4A accommodated in a smoking substitute device.

### DETAILED DESCRIPTION

Aspects and embodiments of the present disclosure will now be discussed with reference to the accompanying figures. Further aspects and embodiments will be apparent to those skilled in the art. All documents mentioned in this text are incorporated herein by reference.

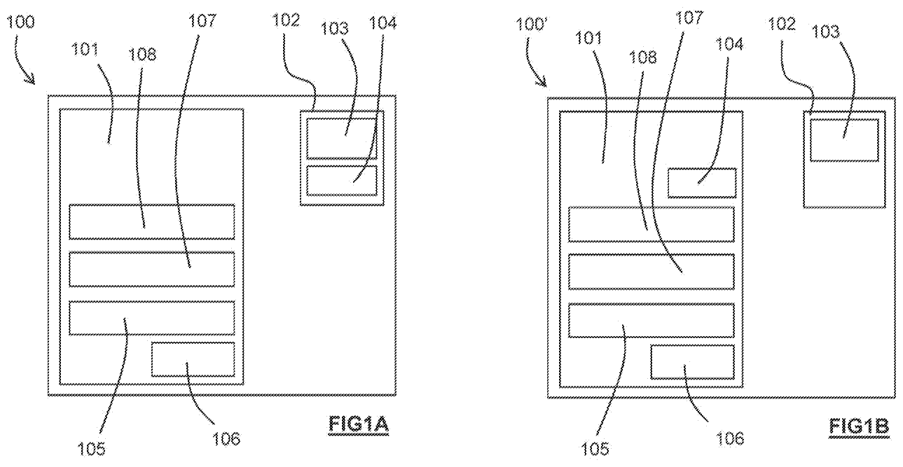

FIG. 1A is a schematic providing a general overview of a smoking substitute system 100. The system 100 includes a smoking substitute device 101 and an aerosol-forming article in the form of a consumable 102, which comprises an aerosol former 103. The system is configured to vaporise the aerosol former by heating the aerosol former 103 (so as to form a vapour/aerosol for inhalation by a user).

In the illustrated system, the heater 104 forms part of the consumable 102 and is configured to heat the aerosol former 103. In this variation, the heater 104 is electrically connectable to the power source 105, for example, when the consumable 102 is engaged with the device 101. Heat from the heater 104 vaporises the aerosol former 103 to produce a vapour. The vapour subsequently condenses to form an aerosol, which is ultimately inhaled by the user.

The system 100 further comprises a power source 105 that forms part of the device 101. In other embodiments the power source 105 may be external to (but connectable to) the device 101. The power source 105 is electrically connectable to the heater 104 such that it is able to supply power to the heater 104 (i.e., for the purpose of heating the aerosol former 103). Thus, control of the electrical connection of the power source 105 to the heater 104 provides control of the state of the heater 104. The power source 105 may be a power store, for example a battery or rechargeable battery (e.g., a lithium-ion battery).

The system 100 further comprises an I/O module comprising a connector 106 (e.g., in the form of a USB port, Micro USB port, USB-C port, etc.). The connector 106 is configured for connection to an external source of electrical power, e.g., a mains electrical supply outlet. The connector 106 may be used in substitution for the power source 105. That is the connector 106 may be electrically connectable to the heater 104 so as to supply electricity to the heater 104. In such embodiments, the device may not include a power source, and the power source of the system may instead comprise the connector 106 and an external source of electrical power (to which the connector 106 provides electrical connection).

In some embodiments, the connector 106 may be used to charge and recharge the power source 105 where the power source 105 includes a rechargeable battery.

The system 100 also comprises a user interface (UI) 107. Although not shown, the UI 107 may include input means to receive commands from a user. The input means of the UI 107 allows the user to control at least one aspect of the operation of the system 100. The input means may, for example, be in the form of a button, touchscreen, switch, microphone, etc.

The UI 107 also comprises output means to convey information to the user. The output means may, for example, comprise lights (e.g., LEDs), a display screen, speaker, vibration generator, etc.

The system 100 further comprises a controller 108 that is configured to control at least one function of the device 101. In the illustrated embodiment, the controller 108 is a component of the device 101, but in other embodiments may be separate from (but connectable to) the device 101. The controller 108 is configured to control the operation of the heater 104 and, for example, may be configured to control the voltage applied from the power source 105 to the heater 104. The controller 108 may be configured to toggle the supply of power to the heater 104 between an on state, in which the full output voltage of the power source 105 is applied to the heater 104, and an off state, in which the no voltage is applied to the heater 104.

Although not shown, the system 100 may also comprise a voltage regulator to regulate the output voltage from the power source 105 to form a regulated voltage. The regulated voltage may then be applied to the heater 104.

In addition to being connected to the heater 104, the controller 108 is operatively connected to the UI 107. Thus, the controller 108 may receive an input signal from the input means of the UI 107. Similarly, the controller 108 may transmit output signals to the UI 107. In response, the output means of the UI 107 may convey information, based on the output signals, to a user. The controller also comprises a memory 109, which is a non-volatile memory. The memory 109 includes instructions, which, when implemented, cause the controller to perform certain tasks or steps of a method.

FIG. 1B is a schematic showing a variation of the system 100 of FIG. 1A. In the system 100′ of FIG. 1B, the heater 104 forms part of the device 101, rather than the consumable 102. In this variation, the heater 104 is electrically connected to the power source 105.

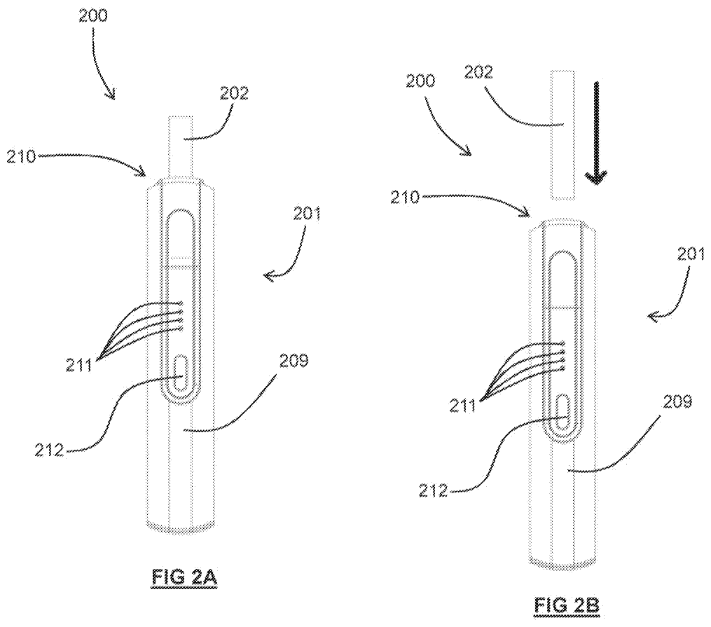

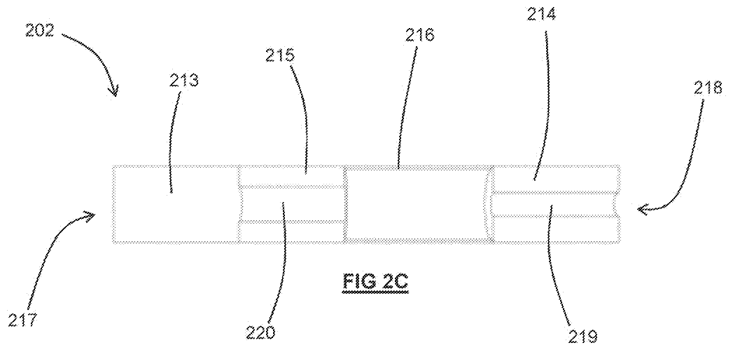

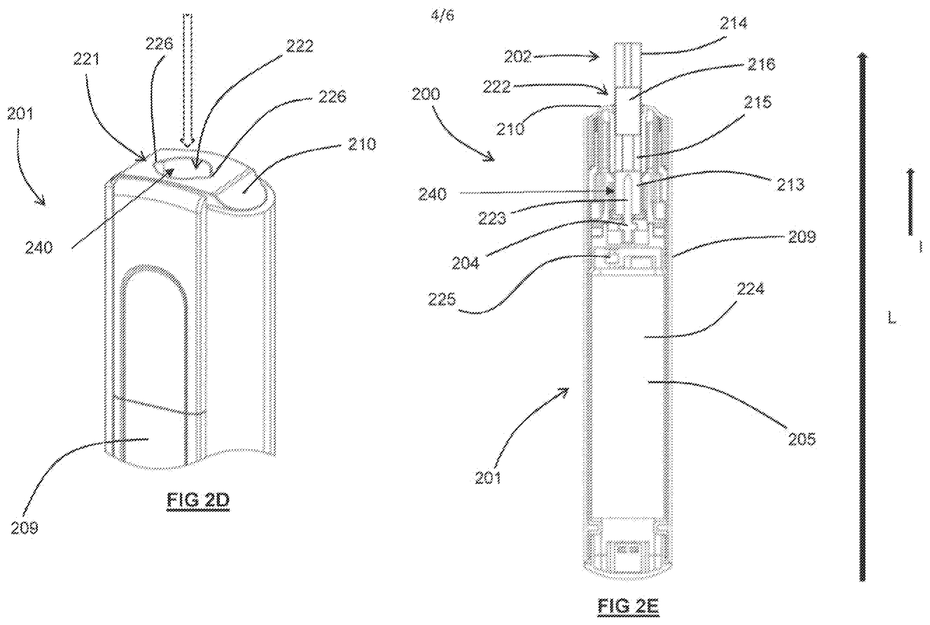

FIGS. 2A and 2B illustrate a heated-tobacco (HT) smoking substitute system 200. The system 200 is an example of the systems 100, 100′ described in relation to FIG. 1A or 1B. System 200 includes an HT device 201 and an HT consumable 202. The description of FIGS. 1A and 1B above is applicable to the system 200 of FIGS. 2A and 2B, and will thus not be repeated.

The device 201 and the consumable 202 are configured such that the consumable 202 can be engaged with the device 201. FIG. 2A shows the device 201 and the consumable 202 in an engaged state, whilst FIG. 2B shows the device 201 and the consumable 202 in a disengaged state.

The device 201 comprises a body 209 and cap 210. In use the cap 210 is engaged at an end of the body 209. Although not apparent from the figures, the cap 210 is moveable relative to the body 209. In particular, the cap 210 is slideable and can slide along a longitudinal axis of the body 209.

The device 201 comprises an output means (forming part of the UI of the device 201) in the form of a plurality of light-emitting diodes (LEDs) 211 arranged linearly along the longitudinal axis of the device 201 and on an outer surface of the body 209 of the device 201. A button 212 is also arranged on an outer surface of the body 209 of the device 201 and is axially spaced (i.e., along the longitudinal axis) from the plurality of LEDs 211.

FIG. 2C shows a detailed section view of the consumable of 202 of the system 200. The consumable 202 generally resembles a cigarette. In that respect, the consumable 202 has a generally cylindrical form with a diameter of 7 mm and an axial length of 70 mm. The consumable 202 comprises an aerosol forming substrate 213, a terminal filter element 214, an upstream filter element 215 and a spacer element 216. In other embodiments, the consumable may further comprise a cooling element. A cooling element may exchange heat with vapour that is formed by the aerosol-forming substrate 213 in order to cool the vapour so as to facilitate condensation of the vapour.

The aerosol-forming substrate 213 is substantially cylindrical and is located at an upstream end 217 of the consumable 202, and comprises the aerosol former of the system 200. In that respect, the aerosol forming substrate 213 is configured to be heated by the device 201 to release a vapour. The released vapour is subsequently entrained in an airflow flowing through the aerosol-forming substrate 213. The airflow is produced by the action of the user drawing on a downstream 218 (i.e., terminal or mouth) end of the consumable 202.

In the present embodiment, the aerosol forming substrate 213 comprises tobacco material that may, for example, include any suitable parts of the tobacco plant (e.g., leaves, stems, roots, bark, seeds and flowers). The tobacco may comprise one or more of leaf tobacco, stem tobacco, tobacco powder, tobacco dust, tobacco derivatives, expanded tobacco, homogenised tobacco, shredded tobacco, extruded tobacco, cut rag tobacco and/or reconstituted tobacco (e.g., slurry recon or paper recon). For example, the aerosol-forming substrate 213 may comprise a gathered sheet of homogenised (e.g., paper/slurry recon) tobacco or gathered shreds/strips formed from such a sheet.

In order to generate an aerosol, the aerosol forming substrate 213 comprises at least one volatile compound that is intended to be vaporised/aerosolised and that may provide the user with a recreational and/or medicinal effect when inhaled. The aerosol-forming substrate 213 may further comprise one or more additives. For example, such additives may be in the form of humectants (e.g., propylene glycol and/or vegetable glycerine), flavourants, fillers, aqueous/non-aqueous solvents and/or binders.

The terminal filter element 214 is also substantially cylindrical, and is located downstream of the aerosol forming substrate 213 at the downstream end 218 of the consumable 202. The terminal filter element 214 is in the form of a hollow bore filter element having a bore 219 (e.g., for airflow) formed therethrough. The diameter of the bore 219 is 2 mm. The terminal filter element 214 is formed of a porous (e.g., monoacetate) filter material. As set forth above, the downstream end 218 of the consumable 202 (i.e., where the terminal filter 214 is located) forms a mouthpiece portion of the consumable 202 upon which the user draws. Airflow is drawn from the upstream end 217, thorough the components of the consumable 202, and out of the downstream end 218. The airflow is driven by the user drawing on the downstream end 218 (i.e., the mouthpiece portion) of the consumable 202.

The upstream filter element 215 is located axially adjacent to the aerosol-forming substrate 213, between the aerosol-forming substrate 213 and the terminal filter element 214. Like the terminal filter 214, the upstream filter element 215 is in the form of a hollow bore filter element, such that it has a bore 220 extending axially therethrough. In this way, the upstream filter 215 may act as an airflow restrictor. The upstream filter element 215 is formed of a porous (e.g., monoacetate) filter material. The bore 220 of the upstream filter element 215 has a larger diameter (3 mm) than the terminal filter element 214.

The spacer 216 is in the form of a cardboard tube, which defines a cavity or chamber between the upstream filter element 215 and the terminal filter element 214. The spacer 216 acts to allow both cooling and mixing of the vapour/aerosol from the aerosol-forming substrate 213. The spacer has an external diameter of 7 mm and an axial length of 14 mm.

Although not apparent from the figure, the aerosol-forming substrate 213, upstream filter 215 and spacer 216 are circumscribed by a paper wrapping layer. The terminal filter 214 is circumscribed by a tipping layer that also circumscribes a portion of the paper wrapping layer (so as to connect the terminal filter 214 to the remaining components of the consumable 202). The upstream filter 215 and terminal filter 214 are circumscribed by further wrapping layers in the form of plug wraps.

Returning now to the device 201, FIG. 2D illustrates a detailed view of the end of the device 201 that is configured to engage with the consumable 202. The cap 210 of the device 201 includes an opening 221 to an internal cavity 222 (more apparent from FIG. 2D) defined by the cap 210. The opening 221 and the cavity 222 are formed so as to receive at least a portion of the consumable 202. During engagement of the consumable 202 with the device 201, a portion of the consumable 202 is received through the opening 221 and into the cavity 222. After engagement (see FIG. 2B), the downstream end 218 of the consumable 202 protrudes from the opening 221 and thus also protrudes from the device 201. The opening 221 includes laterally disposed notches 226. When a consumable 202 is received in the opening 221, these notches 226 remain open and could, for example, be used for retaining a cover in order to cover the end of the device 201.

The cavity 222 comprises an inner surface 240 or inner wall surface 240, which is substantially straight and smooth and complements the consumable 202. The dashed arrow in FIG. 2D shows the direction of insertion of a cleaning device according to one embodiment of the present disclosure, much like the direction for insertion of a consumable 202. In an alternate embodiment not further depicted, the inner walls may serve as a heating element for the consumable, alternatively or in addition to the heating element 223.

FIG. 2E shows a cross section through a central longitudinal plane through the device 201. The device 201 is shown with the consumable 202 engaged therewith.

The device 201 comprises a heater 204 comprising heating element 223. The heater 204 forms part of the body 209 of the device 201 and is rigidly mounted to the body 209. In the illustrated embodiment, the heater 204 is a rod heater with a heating element 223 having a circular transverse profile. In other embodiments the heater may be in the form of a blade heater (e.g., heating element with a rectangular transverse profile) or a tube heater (e.g., heating element with a tubular form). The smoking substitute device 201 comprises a longitudinal extension L or longitudinal axis L, while the heating element 222 comprises a longitudinal extension I or longitudinal axis I. The longitudinal axis L and the longitudinal axis I are substantially parallel.

The heating element 223 of the heater 204 projects from an internal base of the cavity 222 along a longitudinal axis towards the opening 221. As is apparent from the figure, the length (i.e., along the longitudinal axis) of the heating element is less than a depth of the cavity 222. In this way, the heating element 223 does not protrude from or extend beyond the opening 221.

When the consumable 202 is received in the cavity 222 (as is shown in FIG. 2E), the heating element 223 penetrates the aerosol-forming substrate 213 of the consumable 202. In particular, the heating element 223 extends for nearly the entire axial length of the aerosol-forming substrate 213 when inserted therein. Thus, when the heater 204 is activated, heat is transferred radially from an outer circumferential surface the heating element 223 to the aerosol-forming substrate 213.

Again, cavity 222 comprising an inner wall 240 is depicted that surrounds the consumable when inserted into the cavity. In FIG. 2E, the relevant portion of the cavity may be the surface adjacent to or in the vicinity of the heating element 223.

The device 201 further comprises an electronics cavity 224. A power source, in the form of a rechargeable battery 205 (a lithium-ion battery), is located in electronics cavity 224.

The device 201 includes a connector (i.e., forming part of an 10 module of the device 201) in the form of a USB port 206. The connector may alternatively be, for example, a micro-USB port or a USB-C port for examples. The USB port 206 may be used to recharge the rechargeable battery 205.

The device 201 includes a controller (not shown) located in the electronics cavity 224. The controller comprises a microcontroller mounted on a printed circuit board (PCB). The USB port 206 is also connected to the controller 208 (i.e., connected to the PCB and microcontroller).

The controller 208 is configured to control at least one function of the device 202. For example, the controller 208 is configured to control the operation of the heater 204. Such control of the operation of the heater 204 may be accomplished by the controller toggling the electrical connection of the rechargeable battery 205 to the heater 204. For example, the controller 208 is configured to control the heater 204 in response to a user depressing the button 212. Depressing the button 212 may cause the controller to allow a voltage (from the rechargeable battery 205) to be applied to the heater 204 (so as to cause the heating element 223 to be heated).

The controller is also configured to control the LEDs 211 in response to (e.g., a detected) a condition of the device 201 or the consumable 202. For example, the controller may control the LEDs to indicate whether the device 201 is in an on state or an off state (e.g., one or more of the LEDs may be illuminated by the controller when the device is in an on state).

The device 201 comprises a further input means (i.e., in addition to the button 212) in the form of a puff sensor 225. The puff sensor 225 is configured to detect a user drawing (i.e., inhaling) at the downstream end 218 of the consumable 202. The puff sensor 225 may, for example, be in the form of a pressure sensor, flowmeter or a microphone. The puff sensor 225 is operatively connected to the controller 208 in the electronics cavity 224, such that a signal from the puff sensor 225, indicative of a puff state (i.e., drawing or not drawing), forms an input to the controller 208 (and can thus be responded to by the controller 208).

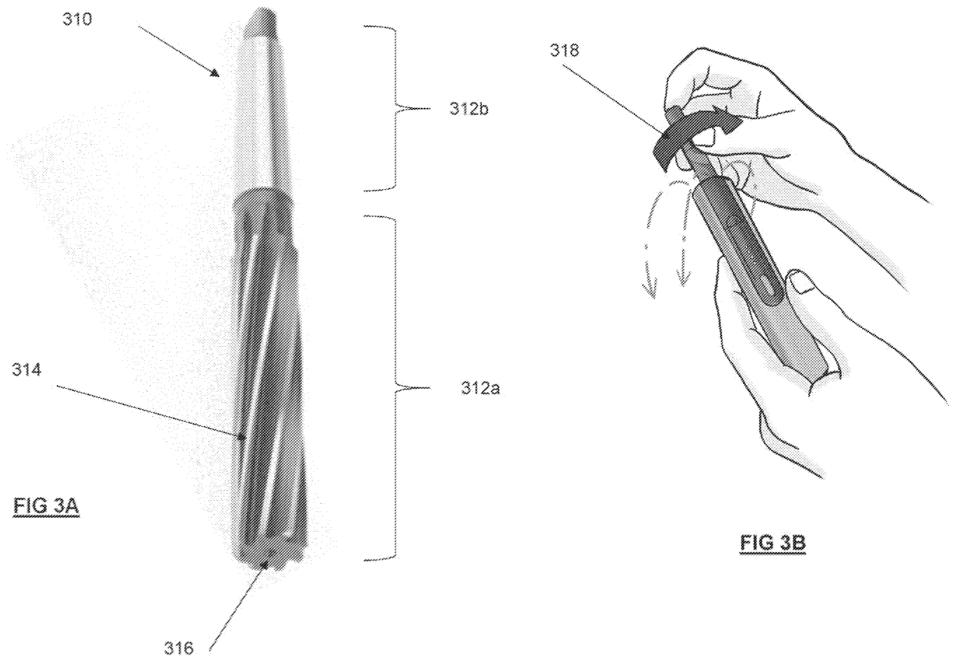

FIG. 3A is a view of an exemplary embodiment of the cleaning device according to the present disclosure.

The cleaning device 310 comprises two sections, a first section 312a and a second section 312b. The first section 312a is arranged for insertion into the cavity of a smoking substitute device, while the second section 312b is embodied as a handle structure for operation by the user of the smoking substitute device, when cleaning the smoking substitute device. The first section 312a is shown with a surface structure 314 to assist in removing debris, dirt or deposits from the smoking substitute device, in particular from the inner surface 240 of the cavity 222, the cavity 222 itself and the heating element 223. To accommodate the heating element 223, in particular to allow a sufficiently deep insertion of the cleaning device 310 into the cavity 222, a cavity 316 is arranged in the first section 312a of the cleaning device 310. This cavity 316 may further stabilize the rotation 318 of the cleaning device 310 about the heating element 223 and in the cavity 222.

The surface structure 314 is depicted as a spiral or helical surface structure, to remove unwanted material from and transport said material to the outside of the cavity 222. Such a spiral structure could be embodied as an Archimedes' type screw surface structure.

FIG. 3B is an exemplary mode of operation of the cleaning device according to the present disclosure. A user operating the cleaning device 310 rotates the cleaning device 310, as depicted by arrow 318. The direction of rotation may be linked to the surface structure 314 of the cleaning element 310, meaning that a certain surface structure may 314 require a rotation in a specific direction (clockwise/counter-clockwise) about the longitudinal axis of the smoking substitute device, to achieve the desired material removing effect.

As may further be seen from FIG. 3B, the first section 312b may extend even outside of the cavity 222, to further assist the removal of material from the cavity, as depicted by the bent downward arrows at the sides of the smoking substitute device. Alternatively, the surface structure 314 may merely assist in dislodging material, debris, dirt or deposits from the cavity 222 without significantly contributing to the removal thereof from the cavity 222.

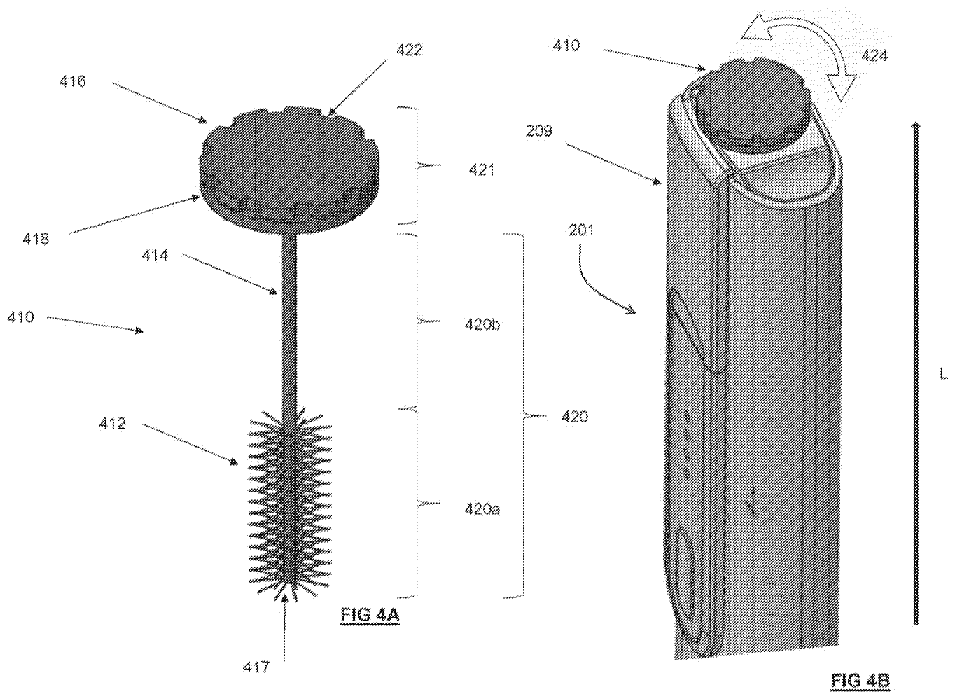

FIG. 4A is a detailed view of a cleaning device according to another embodiment of the present disclosure. The cleaning device 410 comprises a first section 420, divided into a first subsection 420a and a second subsection 420b, and a second section 421. The first subsection 420a comprises a structured surface 412, here exemplarily depicted as a brush-type element. However, it is conceivable that the structured surface 412 is a differently structured element, like a substantially solid element with dimensions comparable to a consumable and a surface adapted for cleaning the cavity, like a rough or abrasive surface.

In FIG. 4A, the first subsection 420a is connected to the second section 421 by the second subsection 420b, exemplarily embodied as a shaft 414 connecting the second section 421 and the first subsection 420a. A further provided is a bearing element 418, in FIG. 4A depicted schematically, and arranged between the first section 420 and the second section 421. Here, the bearing element may be an element having a bore in which the shaft of subsection 420b rotates. Other types of bearing elements, e.g., ball bearings and roller bearings, may be employed likewise.

The second section 421 is embodied as a thumb wheel 416 having indentations 422 to allow sufficient friction between a finger of a user operating the cleaning device 410 and the thumb wheel 416.

Shown only schematically is a cavity 417 at the open end of the second section 420a for accommodating a heating element 223. The cavity may receive the heating element 222 which thus acts as a point of rotation, further stabilizing the rotation of the cleaning device 410 in the cavity 222. With the heating element 223 received, the cleaning device 410 comprises two anchor points for turning about, one being the bearing element and the other one being the heating element 223. This may result in a stable rotation, when turning the thumb wheel 416, in particular with a force acting from the side, like a thumb of a user holding the smoking substitute device 201.

FIG. 4B is a detailed view of a cleaning device according to the present disclosure accommodated in a smoking substitute device. The cleaning device 410 is inserted in the cavity of smoking substitute device 201, and is arranged substantially parallel to longitudinal axis L. The cleaning device is substantially flush with the body 209 of the smoking substitute device 209 and may now be rotated, as indicated by arrows 424.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the disclosure in diverse forms thereof.

While the disclosure has been described in conjunction with the exemplary embodiments described above, many equivalent modifications and variations will be apparent to those skilled in the art when given this disclosure. Accordingly, the exemplary embodiments of the disclosure set forth above are considered to be illustrative and not limiting. Various changes to the described embodiments may be made without departing from the spirit and scope of the disclosure.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, +/−10%.

The words “preferred” and “preferably” are used herein refer to embodiments of the disclosure that may provide certain benefits under some circumstances. It is to be appreciated, however, that other embodiments may also be preferred under the same or different circumstances. The recitation of one or more preferred embodiments therefore does not mean or imply that other embodiments are not useful, and is not intended to exclude other embodiments from the scope of the disclosure, or from the scope of the claims.

### Illustrative Embodiments

Various features and advantages of the disclosure are set forth in the following numbered clauses:

Clause 1: A cleaning device for cleaning a smoking substitute device, the cleaning device comprising: a first section adapted for insertion into a consumable receiving cavity of a smoking substitute device, a second section adapted for operation by a user, and a bearing element arranged between the first section and the second section.

Clause 2: The cleaning device according to the preceding clause, wherein, when inserted into the cavity, the bearing element is adapted to remain in a fixed position relative to the smoking substitute device when rotating the first section and the second section, and wherein the first section and the second section are rotatable relative to the smoking substitute device and the bearing element.

Clause 3: The cleaning device according to at least one of the preceding clauses, wherein the second section is adapted to remain outside of the smoking substitute device when the first section is inserted and while the cleaning device is being operated by the user; and wherein the first section and the second section are rotatable relative to the smoking substitute device and about the bearing element along a longitudinal axis (L) of the smoking substitute device.

Clause 4: The cleaning device according to at least one of the preceding clauses, wherein at least a first subsection of the first section is adapted for cleaning the cavity and/or a heating element arranged in the cavity.

Clause 5: The cleaning device according to the preceding clause, wherein the first section, at least with the first subsection, comprises a surface structure for cleaning an inner wall surface of the cavity, in particular for removing debris, dirt and/or deposits from the cavity and/or the inner wall surface of the cavity.

Clause 6: The cleaning device according to the preceding clause, wherein the surface structure is one structure out of the group consisting of a rough surface structure, an abrasive surface structure, a structured surface structure, structured surface structure comprising a sharpened edge, and a brush type surface structure.

Clause 7: The cleaning device according to at least one of the preceding clauses, further comprising a cavity for at least partly receiving a heating element of the smoking substitute device when inserted into the cavity.

Clause 8: The cleaning device according to the preceding clause, wherein the cleaning device is adapted to be rotated about the heating element.

Clause 9: The cleaning device according to at least one of clauses 7 and 8, wherein the cleaning device is adapted for at least partly cleaning the heating element, in particular when the cleaning device is inserted, removed and/or rotated.

Clause 10: The cleaning device according to at least one of the preceding clauses, wherein the cleaning device is adapted to remain in the smoking substitute device for an extended time acting as a cap for closing the cavity when the smoking substitute device is not in use.

Clause 11: The cleaning device according to at least one of the preceding clauses, wherein the second section comprises a structured surface for operating, in particular rotating, the cleaning device by a user holding the smoking substitute device while using a finger of the same hand that is holding the smoking substitute device for operation.

Clause 12: A system, comprising a cleaning device according to at least one of the preceding clauses and a smoking substitute device.

Clause 13: The system according to the preceding clause, wherein the smoking substitute device further comprises a consumable receiving cavity, and a heating element arranged in the cavity, in particular a rotationally symmetric heating element, further in particular a rod shaped heating element, and wherein the cleaning device is adapted to be rotated about the heating element when inserted into the cavity.

Clause 14: A method of cleaning a smoking substitute device by using a cleaning device according to at least one of clauses 1 to 11, comprising the steps of inserting the cleaning device into a cavity of the smoking substitute device, and rotating the cleaning device about the heating element of the smoking substitute device and the bearing element.

Clause 15: Use of a cleaning device according to at least one of clauses 1 to 11 for cleaning a smoking substitute device.

What is claimed is:

1. A cleaning device for cleaning a smoking substitute device, the cleaning device comprising
a first section comprising a generally cylindrical outer surface, wherein at least part of the first section is adapted for insertion into a smoking substitute device consumable receiving cavity of a smoking substitute device,
wherein at least part of the outer surface of the first section is adapted for cleaning the cavity, and
wherein at least the first section is substantially rigid.

2. The cleaning device according to the preceding claim,
wherein the generally cylindrical outer surface comprises a surface structure for cleaning an inner wall surface of the cavity.

3. The cleaning device according to the preceding claim,
wherein the surface structure is one structure out of the group consisting of a rough surface structure, an abrasive surface structure, a structured surface structure, structured surface structure comprising a sharpened edge, a reamer type surface structure, and an Archimedes screw type surface structure.

4. The cleaning device according to at least one of the preceding claims 2 and 3,
wherein the surface structure is adapted for removing debris, dirt and/or deposits from the cavity and/or the inner wall surface of the cavity.

5. The cleaning device according to at least one of the preceding claims 2 to 4,
wherein the surface structure is arranged to transport deposits, dirt and/or debris from the cavity to the outside of the smoking substitute device.

6. The cleaning device according to at least one of the preceding claims,
wherein the cleaning device is adapted for rotation in the cavity for cleaning the cavity and/or for cleaning the inner wall surface of the cavity, in particular for transporting the deposits, dirt and/or debris from the cavity to the outside of the smoking substitute device.

7. The cleaning device according to at least one of the preceding claims, further comprising a cavity for at least partly receiving a heating element of a smoking substitute device.

8. The cleaning device according to the preceding claim,
wherein the cleaning device is adapted for at least partly cleaning the heating element, in particular when the cleaning device is inserted, removed and/or rotated.

9. The cleaning device according to at least one of the preceding claims, further comprising a second section, wherein the second section is adapted for operation by a user of the smoking substitute device, in particular for inserting, removing and rotating the cleaning device when inserted in the smoking substitute device.

10. A system, comprising a cleaning device according to at least one of the preceding claims and a smoking substitute device.

11. The system according to the preceding claim, wherein the smoking substitute device comprises a cavity and a heating element.

12. The system according to at least one of the preceding claims, wherein the cleaning device is adapted to clean the cavity and/or the heating element, in particular to remove debris, dirt and/or deposits from at least one of the cavity, the inner wall surface of the cavity and the heating element of the smoking substitute device.

13. The system according to the preceding claim, wherein removing debris, dirt and/or deposits from at least one of the cavity, the inner wall surface of the cavity and the heating element of the smoking substitute device further comprises removing said debris, dirt and/or deposits from the smoking substitute device, in particular by rotating the cleaning device.

14. A method of cleaning a smoking substitute device by using a cleaning device according to at least one of claims 1 to 9, comprising the steps of
inserting the cleaning device into a cavity of the smoking substitute device, so that the first section is at least partially inserted into the cavity, and
rotating the cleaning device to remove debris, dirt and/or deposits from at least one of the cavity, the inner wall surface of the cavity and the heating element of the smoking substitute device.

15. Use of a cleaning device according to at least one of claims 1 to 9 for cleaning a smoking substitute device.
